(19) United States
(12) Patent Application Publication
(10) Pub. No.: US 2013/0002168 A1
(43) Pub. Date: Jan. 3, 2013

(54) PROGRAMMABLE SOLID STATE ILLUMINATING SYSTEM AND THE CONTROLLING METHOD THEREOF

(75) Inventor: James Rhodes, Tempe, AZ (US)

(73) Assignee: VERDE DESIGNS, INC., Tempe, AZ (US)

(21) Appl. No.: 13/171,818

(22) Filed: Jun. 29, 2011

(51) Int. Cl. H05B 37/02

(52) U.S. Cl. 315/307

(57) ABSTRACT

The invention provides a programmable solid state illuminating system and the controlling method thereof. The programmable solid state illuminating system is capable of controlling the property of a light ray emitted thereby in accordance with a user command inputted by a user. The system previously described comprises a lighting device, a driving device and an external controlling device, wherein the external controlling device comprises an outputting interface module, an inputting interface, a communicating module and a data processing module. Accordingly, the programmable solid state illuminating system of the present invention provides a simple, low cost and reliable way for adjusting the property of the light emitted by the lighting device and the user only need one inventory for various types of end products.

### BACKGROUND OF THE INVENTION

1. Field of the Invention

The present invention relates to a programmable solid state illuminating system and a controlling method thereof.

2. Description of the Prior Art

Nowadays, as solid state illuminating systems becomes more and more popular in the market, there are various types of solid state illumination driving systems. The driving system is basically utilized to provide constant current or constant voltage to the solid state illumination device or solid state illumination method in order to maintain a constant luminous output thereof. However, the traditional driving systems are purchased at a distinct current setting/set-point. Different pieces of hardware are required to implement the different current requirements of various solid state illuminating systems. Accordingly, the traditional solid state illumination driving system is relatively not easy for the user to utilize across different types of light sources/devices.

Traditional solid state illumination driving systems also utilize either none, or one specific industry standard illumination dimming method, therefore, each of the various traditional solid state illumination driving systems require the corresponding pieces of driving hardware to implement different dimming methods thereof.

Therefore, a need exists, for an intelligent and modular solid state illuminating driving system which is capable of supporting various types of solid state illumination devices having various electrical characteristics, supporting various dimming standards, and is modular in nature so as to offer the features previously described in a single solid state illuminating system.

### SUMMARY OF THE INVENTION

The present invention provides a programmable solid state illuminating system. The programmable solid state illuminating system is capable of controlling the property of a light ray emitted thereby in accordance with a user command and comprises a lighting device, a driving device and an external controlling device.

The lighting device is utilized for converting electricity energy into light rays. The driving device, electrically connected to the lighting device, is utilized for controlling the lighting device in accordance with a predetermined setting list. The predetermined setting list comprising at least one changeable feature task, each of the changeable feature task comprises a feature value correspondingly. The external controlling device is utilized for amending the predetermined setting list of the driving device in accordance with the user command.

The external controlling device comprises an outputting interface module for displaying the changeable feature task and the corresponding feature value to the user; an inputting interface module, for obtaining the user command from the user; a communicating module, for establishing a connection among the driving device and the external controlling device; and a data processing module, electronically connected with the outputting interface module, the inputting interface module and the communicating module, for amending the predetermined setting list in accordance with the user command. Moreover, the communicating module can be a wireless communicating device which is capable of establishing a wireless connection with the corresponding communicating device. Moreover, instead of the wireless communicating device, the communicating module can also be connected with the driving device by mechanical means.

Furthermore, the changeable feature task can be voltage, current, power consumption rate, color rendering index, color coordinates, luminance, wavelength, the on/off status or the on/off timing of the light ray, dimming method, or any other electrical characteristic of the lighting device or the light ray emitted thereby.

Another aspect of the invention generally provides a method of controlling a programmable solid state illuminating system. The programmable solid state illuminating system is utilized for amending a predetermined setting list of a driving device in accordance with a user command for adjusting the property of the light rays emitted by a solid state lighting device. The method of controlling a programmable solid state illuminating system comprises the steps of obtaining a predetermined setting list, wherein the predetermined setting list comprises at least one changeable feature task, and each of the changeable feature task has a feature value correspondingly; displaying the changeable feature task and the correspondingly feature value to the user; obtaining a user command from the user; amending the feature value of each of the changeable feature task in accordance with the user command; and generating light ray in accordance with the predetermined setting list.

### BRIEF DESCRIPTION OF THE APPENDED DRAWINGS

The teachings of the present invention can be readily understood by considering the following detailed description in conjunction with the accompanying drawings, in which:

FIG. 1A shows a schematic view of one embodiment of a programmable solid state illuminating system.

FIG. 1B shows a function block diagram of one embodiment of a programmable solid illuminating system.

FIG. 2 shows a schematic view of another embodiment of a programmable solid state illuminating system.

FIG. 3 shows a schematic view of another embodiment of a programmable solid state illuminating system.

FIG. 4 shows a flow chart of one embodiment of a programmable solid state illuminating system.

To facilitate understanding, identical reference numerals have been used, where possible to designate identical elements that are common to the figures.

### DETAILED DESCRIPTION OF THE INVENTION

The invention generally provides a programmable solid state illuminating system 1, capable of controlling the property of light rays emitted thereby in accordance with at least one user command inputted by a user. The invention is illustratively described below in reference to a programmable solid state illuminating system 1 having the advantage of supporting a programmable function provided by an external controlling device 12 which has an inputting interface module 122 and an outputting interface module 124, wherein the external controlling device 12 is detachable. However, devices, components, modules or the items of the present invention are not limited to the embodiment described below, it should be understood that the devices, components, modules or the items of the present invention can be replaced by any other objects or means having the same corresponding functions.

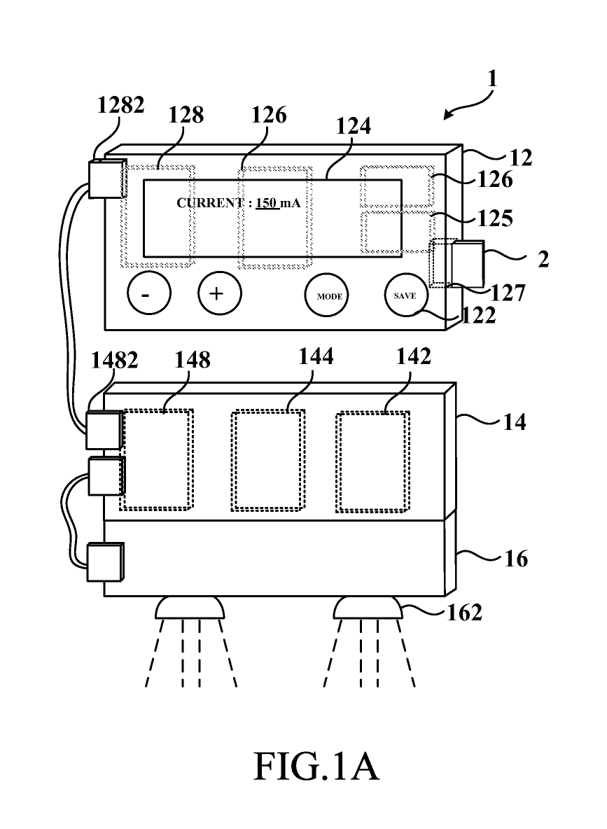

For clarity and ease of description, an actuation sequence of one embodiment of the invention is described below with reference with FIG. 1A to FIG. 4.

FIG. 1A is a schematic view of one embodiment of a programmable solid state illuminating system 1. FIG. 1B is a function block diagram of one embodiment of a programmable solid state illuminating system 1 (for the clarity, hereinafter called as the system). With reference to FIGS. 1A and 1B, the system 1 comprises an external controlling device 12, a driving device 14 and a lighting device 16.

The lighting device 16 is capable of converting electricity energy into a light ray. In the present embodiment, the lighting device 16 comprises two light emitting modules 162, wherein each of the two light emitting modules 162 comprises, but not limited to, a plurality of light emitting diode chips. Especially to deserve to be mentioned, the number of the light emitting module 162 is not limited to two and can be modified in accordance with the requirement of the user.

Each of the plurality of the light emitting diode chips can be controlled independently by the driving device 14 in accordance with the predetermined setting list of the driving device 14. Furthermore, by controlling the voltage, current or even time related factor inputted to the light emitting modules 162, the light emitting modules 162 are capable of emitting various types of light ray having different illumination, color rendering index, color coordinates or wavelength.

Moreover, the driving device 14 has a plurality functions, for example, by the control of the driving device 14, the lighting device 16 can be switched on or off under a certain condition. The said certain condition can be a time related parameter, for example, the lighting device 16 shall be switched off automatically as the time reach 7 o'clock in the morning and the lighting device will be switched to the on mode for 12 hours before it is automatically switched off.

Furthermore, the driving device 14 is also capable of activating the PWM dimming function or analog dimming function for adjusting the brightness and contrast of the light ray which is emitted by the lighting device 16. Furthermore, the driving device 14 further having the function of overvoltage protection. Nevertheless, most of the capability of the driving device 14 previously described is software based and the corresponding parameters of the functions can be modified by the user.

Furthermore, the lighting device 16 is not limited to the composition of light emitting diodes, each of the light emitting diodes can be replaced by a laser emitting diode, an ultraviolet emitting diode or any other solid state lighting devices respectively.

The driving device 14 is utilized to control the said lighting device 16 in accordance with a predetermined setting stored in a storing module 145 of the driving module previously described. The driving device 14 is electronically connected to the lighting device 16 and the external controlling device 12 an can be utilized to control the lighting device 16 in accordance with a predetermined setting list stored in the storing module 145 of the driving device 14. Especially to deserve to be mentioned, the driving device 14 has an analog mode and a digital mode. The driving device 14 is capable of controlling the lighting device 16 or any other component in analog format or digital format while in analog mode and digital mode correspondingly. Furthermore, the driving device 14 can be switched among the analog mode and the digital mode by the user via the inputting interface module 122. Please refer to the FIG. 1B, the driving device 14 further comprises a data processing module 146, a communicating module 148, a storing module 145 and, a power supplying module 143.

The storing module 145 of the driving device 14 is utilized to store a predetermined setting list. The predetermined setting list is formed of at least one changeable feature task or unchangeable feature task. Each of the changeable feature task and unchangeable feature task is corresponded to a feature value representing the property of the feature task correspondingly.

Generally, the storing module 145 is a flash memory which is a non-volatile storage means that can be electrically erased and reprogrammed. However, the storing module 145 is not limited to the flash memory, it can also be any other device or module which has the same capability of preserving the data stored therein without continuous power supply. Furthermore, the changeable feature task may represent voltage, current, power consumption rate, color rendering index, color coordinates, luminance, wavelength, the on/off status or the on/off timing of the light ray.

The communicating modules 148 of the driving device 14 and the communicating module 128 of the external controlling device 12 are utilized to establish a connection therebetween for exchanging data or signal therebetween. Please refer to the FIG. 1B, generally, the communicating module 128 of the driving device 14 further comprises a cable plugging interface 1482 for plugging a cable connected to the external controlling device 12. The cable plugging interface 1482 of the detachable allows the external controlling device 12 to plug in or out easily and quickly to form the connection of the driving device 14. However, the cable plugging interface 1482 of the driving device 14 is dispensable while the cable can also be welded on the connecting pads disposed on the surface of the communicating module 148. Furthermore, the cable plugging interface 1482 of the driving device 14 is also dispensable while the communicating module 148 is able to connect with the detachable controlling interface via a wireless interface.

The power supplying module 143 of the driving device 14 is utilized to regulate or adjust the voltage or current of the power source in accordance with the requirement of the lighting device and supply the adjusted power to the driving device 14 itself and the lighting device 16. Furthermore, the power supplying module 142 is also capable of converting the AC power source to DC power source to obtain the power from the AC power source. However, the AC/DC converting function of the power supplying module 143 is dispensable in accordance with the requirement of the user.

The data processing module 146 of the driving device 14 is electronically connected to the communicating module 148, the power supplying module 143 and the storing module 145. The data processing module 146 of the driving device 14 is capable of controlling the lighting device 16 in accordance with the predetermined setting list. The data processing module 146 of the driving device 14 also controls the power supplying module 143 for providing the electricity to the lighting device 16. Furthermore, the data processing module 146 of the driving device 14 is capable of identifying the changeable feature task and the unchangeable feature task from the predetermined setting list for allowing the external controlling device 12 to obtain the changeable feature task only from the driving device 14.

The data processing module 146 of the driving device 14 is capable of controlling the lighting device 16 in accordance with the predetermined setting list. The data processing module 146 of the driving device 14 also controls the power supplying module 143 for providing the electricity to the lighting device 16. Furthermore, the data processing module 146 of the driving device 14 is capable of identifying the changeable feature task and the unchangeable feature task from the predetermined setting list for allowing the external controlling device 12 to obtain the changeable feature task only from the driving device 14.

As shown in FIG. 1B, the external controlling device 12 comprises an inputting interface module 122, an outputting interface module 124, a data processing module 126, a storing module 125, a communicating module 128 and an expansion module 127. The external controlling device 12 is utilized to amend the predetermined setting of the driving device 14 in accordance with the user command. Moreover, the external controlling device 12 of the present invention integrated with the inputting interface module 122, the outputting interface module 124 and the data processing module 126 can be treaded as a independent embedded system installed within a single piece of device which can be detached from the driving device 14 once the amending process of the predetermined setting of the driving device 14 accomplished.

The expansion module 127 of the external controlling device 12 is electronically connected to the data processing module 126. The expansion module 127 allows the user to add an expansion kit 2 to the external controlling device 12 for providing extra functions or to update the firmware of the external controlling device 12. The expansion kit 2 can be an input-output (10) module, a wireless communicating module, a data storing device for storing data or any other devices that can improve the function or capability of the present invention. However, the expansion module 127 is dispensable and not necessary for the present invention.

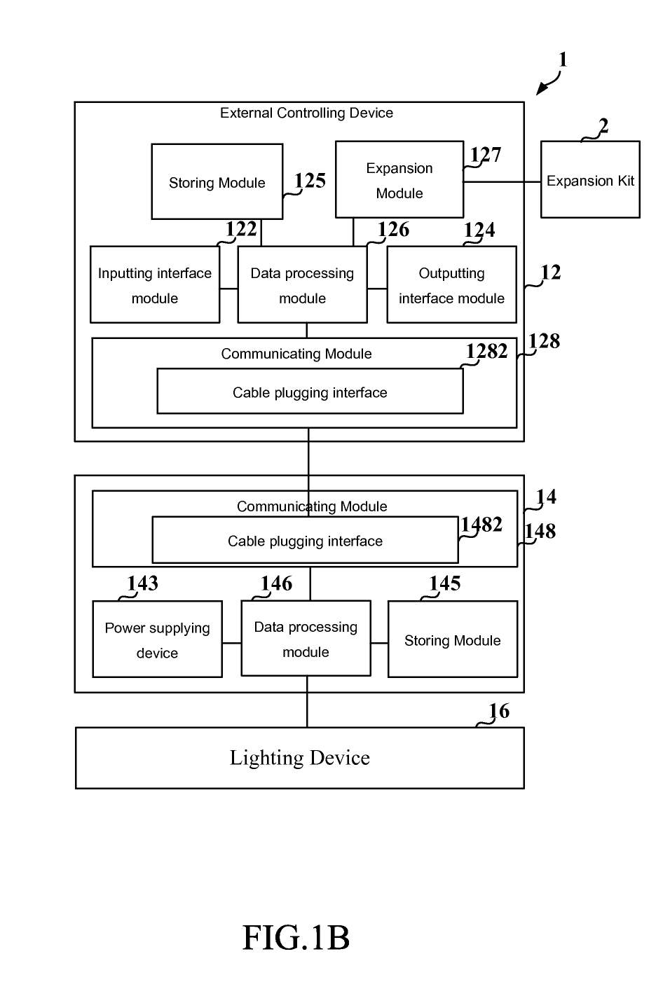

The outputting interface module 124 is utilized to present the changeable feature task of the predetermined setting list and the corresponding feature value to the user. Generally, the outputting interface module 124 comprises a LCD displaying screen, however, the outputting interface module 124 is not limited to the LCD displaying screen. It can be any mean, device, or module which is capable of presenting the data to the user. For example, the outputting interface module 124 may be a CRT monitor of a computer or a projector. Furthermore, the outputting interface module 124 can also be a graphical interface formed of a plurality of light emitting units which represent the corresponding features and the intensity thereof as shown in FIG. 2.

The inputting interface module 122 is utilized to provide an interface for the user to input a user command. Generally, the inputting interface module 122 is formed of a plurality of capsense buttons, however, the inputting interface module 122 can be any mean, device, or module which is capable of providing the user an interface to input the user command. For example, the inputting interface module 122 can also be a keyboard, a mouse, or any other type of button beside the capsense buttons. Moreover, the inputting interface module 122 and the outputting interface module 124 can be integrated to be a single module, for example, a touch panel having the functions previously described correspondingly. Moreover, the inputting interface module 122 may comprise a save button for allowing the user to save the user command in the storing module 145 of the external controlling device 12.

The communicating module 128 of the external controlling device 12 is utilized to establish a connection among the driving device 14 and the external controlling device 12 for exchanging data or signal therebetween. In the present embodiment, the communicating module 128 further comprises a cable plugging interface for plugging a cable extended form the lighting device 16, so as to connect the external controlling device 12 with the driving device 14. The cable plugging interface 1282 of the external controlling device 12 allows the external controlling device 12 plug in or out easily and quickly from the connection of the driving device 14. In another word, the external controlling device 12 is detachable from the driving device 14.

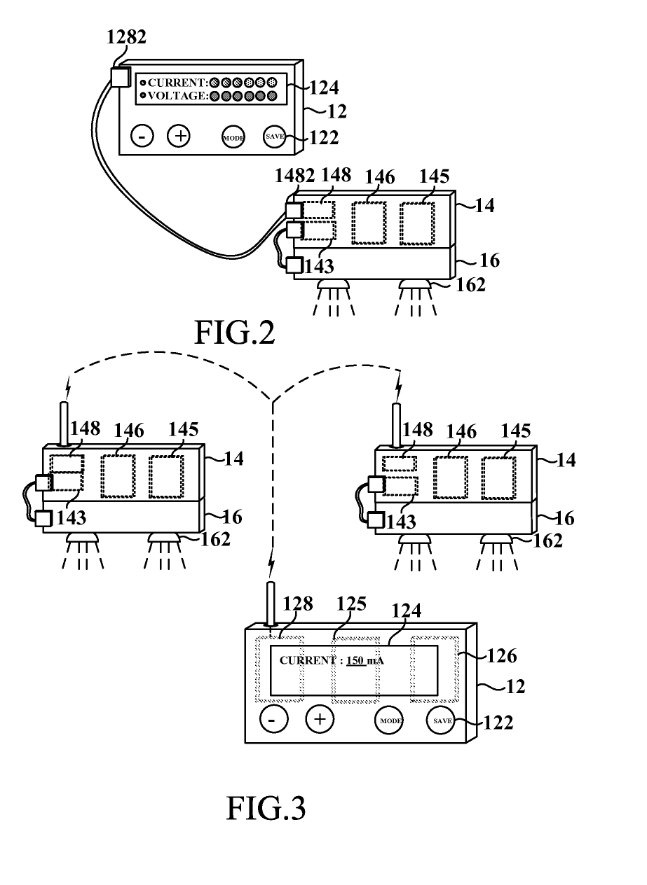

Moreover, the cable plugging interface 1282 is dispensable if the communicating module 128 has a wireless network transmitting function as shown in FIG. 3 for allowing the communicating module 128 to establish a wireless connection with the driving devices 14. Furthermore, by the wireless connection, the external controlling device 12 is capable of connecting with a plurality of driving devices 14 simultaneously. Accordingly, the external controlling device 12 is capable of amending the predetermined setting lists of the plurality of driving devices 14 simultaneously or correspondingly with no wire connection.

The data processing module 146 of the external controlling device 12 is capable of obtaining the predetermined setting list of the driving device 14 in accordance with the user command obtained by the outputting interface module 124, wherein the predetermined setting list comprises the changeable feature task.

The process of amending the predetermined setting list is explained by the following description. Firstly, the data processing module 146 sends a request signal to the data processing module 146 of the driving unit via the communicating module 148 to obtain a changeable feature list having at least one changeable feature task and the corresponding feature value.

Then, the data processing module 126 of the external controlling device 12 converts the changeable feature list to the user readable format and present to the user via the outputting interface module 124. After displaying the changeable feature task and the corresponding feature value to the user, the user may input a user command via the inputting module accordingly, wherein the user command comprises an amended feature value corresponding to each of the feature task previously described.

Then, the user command can be sent to the data processing module 146 of the external controlling device 12. The data processing module 146 will then amend the changeable feature list to generate an amended changeable feature list in accordance with the user command and the feature value therein.

Moreover, if the user pauses the button disposed on the inputting interface of the external controlling device 12, the amended changeable feature list or the user command shall be stored in the storing module 145 of the external controlling device 12. Therefore, the same amended changeable feature list or the user command can be recalled by the user anytime without inputting the user command repeatedly while the external controlling device 12 is attached to another driving device 14 having the same model type.

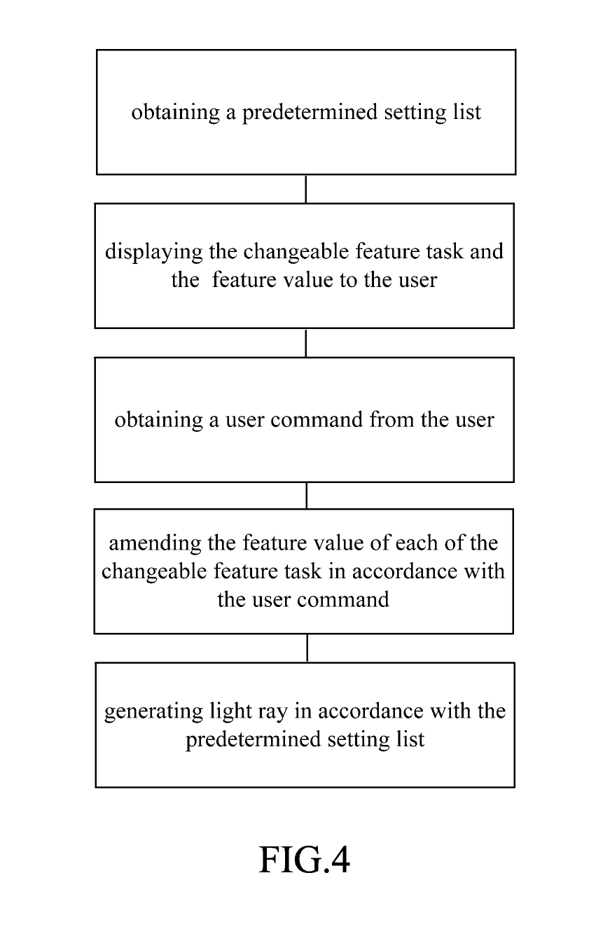

Then, the amended changeable feature list is transmitted to the data processing module 146 of the driving device 14 via the communicating module 148 of the driving device 14 and the external controlling device 12 correspondingly. The predetermined setting list can be updated in accordance with the amended changeable feature list. Eventually, the driving device 14 controls the lighting device 16 in accordance with the updated predetermined setting list. The steps previously described are shown in the FIG. 4. The FIG. 4 depicts a method of controlling the programmable solid state illuminating system, the method comprises the step of obtaining a predetermined setting list, the predetermined setting list comprising at least one changeable feature task, each of the changeable feature task having a feature value correspondingly; displaying the changeable feature task and the correspondingly feature value to the user; obtaining a user command from the user; amending the feature value of each of the changeable feature task in accordance with the user command; and generating light ray in accordance with the predetermined setting list.

In summary, the present invention provides a programmable solid state illuminating system 1 capable of controlling the property of a light ray emitted thereby in accordance with at least one user command inputted by a user

Particularly, the present invention has an external controlling device 12 which is capable of adjusting the property of the light ray emitted by the lighting device 16 by amending the original setting of the driving device 14, wherein the driving device 14 is capable of identifying and outputting the changeable feature task from the original setting and sending it to the external controlling device 12.

Accordingly, the programmable solid state illuminating system 1 provide a simple, low cost and reliable way for adjusting the property of the light emitted by the lighting device 16 and the user only need one inventory for various types of end products, wherein the dimming method of the programmable solid state illuminating system is potentially determined or modified by the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A programmable solid state illuminating system, capable of controlling the property of a light ray emitted thereby in accordance with a user command inputted by a user, which comprising:
a lighting device, for converting electricity energy into the light ray;
a driving device, electrically connected to the lighting device, for controlling the lighting device in accordance with a predetermined setting list, the predetermined setting list comprising at least one changeable feature task, each of the changeable feature task having a feature value correspondingly; and
an external controlling device, for amending the predetermined setting list of the driving device in accordance with the user command.

2. The programmable solid state illuminating system of claim 1, wherein the external controlling device further comprising:
an outputting interface module, for displaying the changeable feature task and the corresponding feature value to the user; and
an inputting interface module, for obtaining the user command from the user.

3. The programmable solid state illuminating system of claim 1, wherein the external controlling device further comprising:
a communicating module, for establishing a connection among the driving device and the external controlling device; and
a data processing module, electronically connected with a outputting interface module, a inputting interface module and the communicating module, for amending the predetermined setting list in accordance with the user command.

4. The programmable solid state illuminating system of claim 1, wherein changeable feature task is voltage, current, power consumption rate, color rendering index, color coordinates, luminance, wavelength, the on/off status or the on/off timing of the light ray.

5. The programmable solid state illuminating system of claim 3, wherein the communicating module is a wireless communicating device.

6. The programmable solid state illuminating system of claim 3, wherein the communicating module is connected with the driving device by mechanical means.

7. The programmable solid state illuminating system of claim 3, wherein the external controlling device further comprising:
an expansion module, for allowing the user to add an expansion kit to the external controlling device for improving the capability of the external controlling device.

8. A method of controlling a programmable solid state illuminating system, the programmable solid state illuminating system utilized for amending a predetermined setting list of a driving device in accordance with a user command for adjusting the property of a light ray emitted by a lighting device, which comprising the following steps:
obtaining a predetermined setting list, the predetermined setting list comprising at least one changeable feature task, each of the changeable feature task having a feature value correspondingly;
displaying the changeable feature task and the correspondingly feature value to the user;
obtaining a user command from the user;
amending the feature value of each of the changeable feature task in accordance with the user command; and
generating light ray in accordance with the predetermined setting list.

9. An external controlling device, for amending a predetermined setting list of a driving device in accordance with a user command, the predetermined setting list comprising at least one changeable feature task, each of the changeable feature task having a feature value correspondingly, the external controlling device comprising:
an outputting interface module, for displaying the changeable feature task and the corresponding feature value to the user,
an inputting interface module, for obtaining the user command from the user
a communicating module, for establishing a connection among the driving device and the external controlling device; and
a data processing module, electronically connected with the outputting interface module, the inputting interface module and the communicating module, for amending the predetermined setting list in accordance with the user command.

10. The external controlling device of claim 9, wherein the feature task represents voltage, current, power consumption rate, color rendering index, color coordinates, luminance, wavelength, the on/off status or the on/off timing of the light ray.

11. The external controlling device of claim 9, wherein the communicating module is a wireless communicating device.

12. The external controlling device of claim 9, wherein the communicating module is connected with the driving device by mechanical means.
